(19) United States
(12) Patent Application Publication
(10) Pub. No.: US 2025/0240406 A1
(43) Pub. Date: Jul. 24, 2025

(54) METHOD OF ENCODING, METHOD OF DECODING, AND SYSTEM

(71) Applicant: GUANGDONG OPPO MOBILE TELECOMMUNICATIONS CORP., LTD., Dongguan, Guangdong (CN)

(72) Inventors: Kazushi SATO, Palo Alto, CA (US); Yue YU, Palo Alto, CA (US); Haoping YU, Palo Alto, CA (US)

(21) Appl. No.: 18/879,485

(22) PCT Filed: May 1, 2023
(86) PCT No.: PCT/US2023/020599

§ 371 Date: Dec. 27, 2024

Related U.S. Application Data
(60) Provisional application No. 63/367,708, filed on Jul. 5, 2022.
(60) Provisional application No. 63/368,761, filed on Jul. 18, 2022.

(51) Int. Cl. H04N 19/105; H04N 19/137; H04N 19/172; H04N 19/176; H04N 19/182; H04N 19/51

(52) U.S. Cl. CPC H04N 19/105; H04N 19/137; H04N 19/172; H04N 19/176; H04N 19/182; H04N 19/51

(57) ABSTRACT

method of encoding by an encoder is provided. The method includes receiving, by at least one processor, a set of frames including a reference frame and a current frame. The method includes performing, by the at least one processor, a multi-hypothesis prediction (MHP) procedure for a coding unit (CU) located in the current frame based on a search block in the reference frame. In response to a size of the search block in the reference frame meeting a threshold size, the method includes selecting, by the at least one processor, a first weighting factor from a first set of more than two weighting factors associated with the MHP procedure.

### CROSS-REFERENCE TO RELATED APPLICATIONS

This application is a U.S. National Stage of International Application No. PCT % US2023/020599, filed May 1, 2023, which claims priority to U.S. Provisional Application No. 63/367,708, entitled “MULTI-HYPOTHESIS PREDICTION FOR VIDEO CODING” and filed on Jul. 5, 2022, and to U.S. Provisional Application No. 63/368,761, entitled “MULTI-HYPOTHESIS PREDICTION FOR VIDEO CODING” and filed on Jul. 18, 2022, the entire disclosures of which are incorporated by reference herein.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, to name a few.

### SUMMARY

According to one aspect of the present disclosure, a method of encoding by an encoder is provided. The method includes receiving, by at least one processor, a set of frames including a reference frame and a current frame. The method includes performing, by the at least one processor, a multi-hypothesis prediction (MHP) procedure for a coding unit (CU) located in the current frame based on a search block in the reference frame. In response to a size of the search block in the reference frame meeting a threshold size, the method includes selecting, by the at least one processor, a first weighting factor from a first set of more than two weighting factors associated with the MHP procedure.

According to a further aspect of the present disclosure, a method of decoding by a decoder is provided. The method includes receiving, by at least one processor, a bitstream that includes a reference frame, a current frame, and an indication of a weighting factor associated with an MHP procedure from an encoder. The weighting factor is associated with a first set of more than two weighting factors when a size of a search block in the reference frame meets a threshold size. The method includes performing, by the at least one processor, the MHP procedure for a CU located in the current frame based on a search block in the reference frame.

According to yet another aspect of the present disclosure, a system for decoding by a decoder is provided. The system includes at least one processor and memory storing instructions. The instructions, when executed by the at least one processor, cause the at least one processor to receive a bitstream that includes a reference frame, a current frame, and an indication of a weighting factor associated with an MHP procedure from an encoder. The weighting factor is associated with a first set of more than two weighting factors when a size of a search block in the reference frame meets a threshold size. The instructions, when executed by the at least one processor, cause the at least one processor to perform the MHP procedure for a CU located in the current frame based on a search block in the reference frame.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a diagram of an example template matching (TM) technique.

FIG. 2 illustrates a block diagram of an exemplary encoding system, according to some embodiments of the present disclosure.

FIG. 3 illustrates a block diagram of an exemplary decoding system, according to some embodiments of the present disclosure.

FIG. 4 illustrates a detailed block diagram of an exemplary encoder in the encoding system in FIG. 2, according to some embodiments of the present disclosure.

FIG. 5 illustrates a detailed block diagram of an exemplary decoder in the decoding system in FIG. 3, according to some embodiments of the present disclosure.

FIG. 6 illustrates an exemplary picture divided into coding tree units (CTUs), according to some embodiments of the present disclosure.

FIG. 7 illustrates an exemplary CTU divided into coding units (CUs), according to some embodiments of the present disclosure.

FIG. 8 illustrates a flowchart of an exemplary method of video encoding, according to some embodiments of the present disclosure.

FIG. 9 illustrates a flowchart of an exemplary method of video decoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

VVC may perform inter frame prediction with a single prediction (P frame) and bi-prediction (B frame), in which one and two hypotheses are utilized to generate the final prediction, respectively. Inter prediction plays a crucial role in removing the temporal redundancy based on high similarities among successive frames. By taking the previously decoded frames as the predictive signal, the compression of the current frame can be converted into coding the residuals after prediction, and entropy coding is adopted to compactly represent the residual signal. Additionally, the relative position of the prediction block compared to the current block, termed motion vector (MV), is also required to be transmitted.

In the enhanced compression model (ECM), a coding tool called multi-hypothesis prediction (MHP) has been proposed. In the multi-hypothesis inter prediction, one or more additional motion-compensated prediction signals are transmitted, in addition to the conventional bi-prediction signals. The resulting overall prediction signal is obtained by sample-wise weighted superposition. With the bi-prediction signal p_{bi}, the first additional signal/hypothesis h₃, and weighting factor α, the resulting prediction signal p₃ is obtained according to expression (1).

$${p}_{3} = ( 1 - α ) * {p}_{bi} + α * {h}_{3} . \qquad ( 1 )$$

The weighting factor α is specified by the syntax element add_hyp_weight_idx as shown below in Table 1.

TABLE 3
add_hyp_weight_idx

| add_hyp_weight_idx | α |
|---|---|
| 0 | ¼ |
| 1 | ~⅛ |

Analogous to the above, more than one additional prediction signal can be used. The resulting overall prediction signal is accumulated iteratively with each additional prediction signal shown below in expression (2).

$${p}_{n + 1} = ( 1 - {α}_{n + 1} ) * {p}_{n} + {α}_{n + 1} * {h}_{n + 1} . \qquad ( 2 )$$

The resulting overall prediction signal is obtained as the last pₙ (e.g., the pₙ having the largest index n). Using existing ECM techniques, up to two additional prediction signals can be used; in other words, n is limited to 2.

The motion parameters of each additional prediction hypothesis can be signaled either explicitly by specifying the reference index, the motion vector predictor index, and the motion vector difference, or implicitly by specifying a merge index, which is a separate multi-hypothesis merge flag that distinguishes between these two signalling modes.

For inter-advanced motion vector prediction (AMVP) mode, MHP is only applied for non-equal weight in the bi-prediction with CU-level weights (BCW).

A combination of MHP and bi-directional optical flow (BDOF) is possible. However, the BDOF is only applied to the bi-prediction signal part of the prediction signal (e.g., the ordinary first two hypotheses).

In the mh_pred_data( ) syntax, add_hyp_weight_idx is transmitted as shown below in Table 2.

TABLE 2
add_hyp_weight_idx in mh_pred_data( )

| | Descriptor |
|---|---|
| mh_pred_data( ) { | |
| ... | |
| add_hyp_weight_idx | ae(v) |
| ... | |
| } | |

The add_hyp_weight_idx element specifies the value of weighting factor α for the MHP in the expression (1).

Under the current ECM, there are restrictions on block size where MHP is applied. If the size of the prediction block is less than 64 pixels, MHP is not applied. If the width or the height of the block is less than 8 pixels, MHP is not applied.

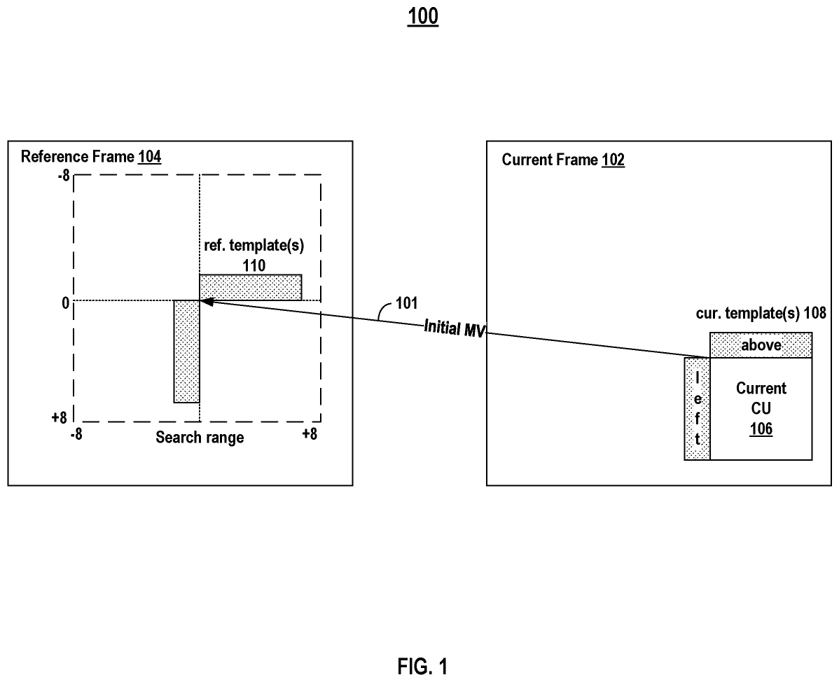

The transmission of motion vector information uses overhead bits within a bitstream. To improve coding efficiency, a template matching (TM) procedure 100 may be used in ECM, as shown in FIG. 1.

Referring to FIG. 1, TM is a decoder-side MV derivation method to refine the motion information of the current CU 106 by finding the closest match between a current template 108 (e.g., above and/or left neighboring blocks of current CU 106) in the current frame 102 and a reference template 110 (e.g., the same size to current template 108) in a reference frame 104. As illustrated in FIG. 1, an initial MV 101 is searched around the initial motion of the current CU 106 within a predetermined search range. TM procedure 100 is executed at the encoder and at the decoder, so there is no need to transmit motion vector information within a bitstream.

The existing MHP procedure suffers from various drawbacks. For instance, as shown in Tables 1 and 2, the number of possible values for α is restricted to 2 values. Such a limited number of possible α values restricts the amount of coding efficiency that can be achieved.

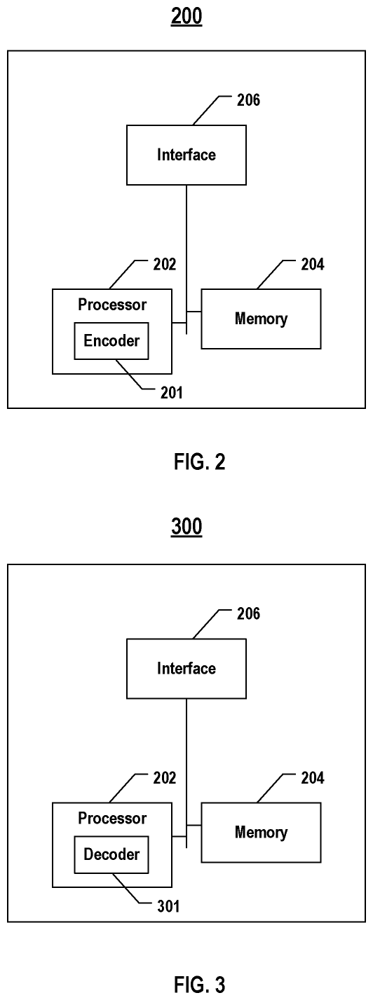

To overcome these and other challenges, the present disclosure provides an exemplary inter prediction procedure that extends the number of possible α values, as shown below in Tables 3 and 4. Having more candidates for weighting factor α may cause an increase in overhead bits, and hence, a loss in coding efficiency if this extension is applied to smaller templates (also referred to as “prediction blocks”). To solve this problem, the exemplary inter prediction procedure proposes the following restrictions. For example, in some embodiments, if the number of pixels of a prediction block is less than 256, the candidate weighting factors shown in Table 1 are applied. Otherwise, the candidate weighting factors shown in Table 3 or in Table 4 may be applied. In some other embodiments, if the width or height of the prediction block is less than 16, the candidate weighting factors shown in Table 1 are applied otherwise, the candidate weighting factors shown in Table 3 or in Table 4 are applied. Additional details of the exemplary inter prediction procedure are described below in connection with FIGS. 2-9.

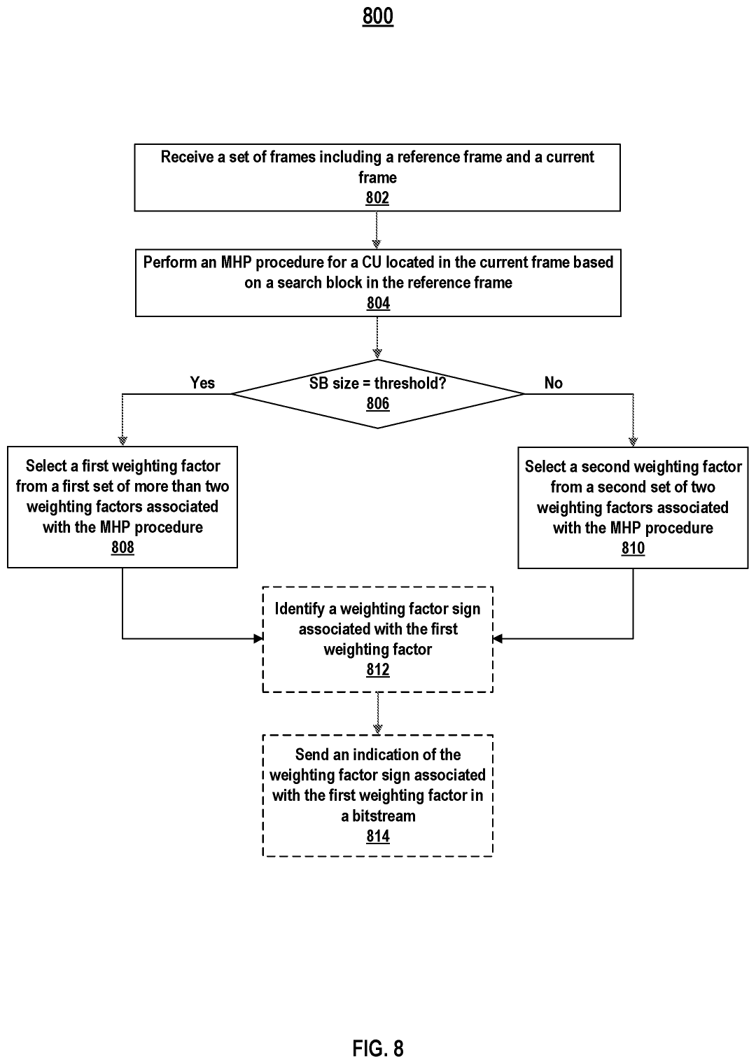

FIG. 2 illustrates a block diagram of an exemplary encoding system 200, according to some embodiments of the present disclosure. FIG. 3 illustrates a block diagram of an exemplary decoding system 300, according to some embodiments of the present disclosure. Each system 200 or 300 may be applied or integrated into various systems and apparatus capable of data processing, such as computers and wireless communication devices. For example, system 200 or 300 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 7 and 8, system 200 or 300 may include a processor 202, a memory 204, and an interface 206. These components are shown as connected to one another by a bus, but other connection types are also permitted. It is understood that system 200 or 300 may include any other suitable components for performing functions described here.

Processor 202 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 7 and 8, it is understood that multiple processors can be included. Processor 202 may be a hardware device having one or more processing cores. Processor 202 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 204 can broadly include both memory (a.k.a, primary/system memory) and storage (a.k.a. secondary memory). For example, memory 204 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 202. Broadly, memory 204 may be embodied by any computer-readable medium, such as a non-transitory computer-readable medium. Although only one memory is shown in FIGS. 7 and 8, it is understood that multiple memories can be included.

Interface 206 can broadly include a data interface and a communication interface that is configured to receive and transmit a signal in a process of receiving and transmitting information with other external network elements. For example, interface 206 may include input/output (I/O) devices and wired or wireless transceivers. Although only one memory is shown in FIGS. 7 and 8, it is understood that multiple interfaces can be included.

Processor 202, memory 204, and interface 206 may be implemented in various forms in system 200 or 300 for performing video coding functions. In some embodiments, processor 202, memory 204, and interface 206 of system 200 or 300 are implemented (e.g., integrated) on one or more system-on-chips (SoCs). In one example, processor 202, memory 204, and interface 206 may be integrated on an application processor (AP) SoC that handles application processing in an operating system (OS) environment, including running video encoding and decoding applications. In another example, processor 202, memory 204, and interface 206 may be integrated on a specialized processor chip for video coding, such as a GPU or ISP chip dedicated to image and video processing in a real-time operating system (RTOS).

As shown in FIG. 2, in encoding system 200, processor 202 may include one or more modules, such as an encoder 201. Although FIG. 2 shows that encoder 201 is within one processor 202, it is understood that encoder 201 may include one or more sub-modules that can be implemented on different processors located closely or remotely with each other. Encoder 201 (and any corresponding sub-modules or sub-units) can be hardware units (e.g., portions of an integrated circuit) of processor 202 designed for use with other components or software units implemented by processor 202 through executing at least part of a program, i.e., instructions. The instructions of the program may be stored on a computer-readable medium, such as memory 204, and when executed by processor 202, it may perform a process having one or more functions related to video encoding, such as picture partitioning, inter prediction, intra prediction, transformation, quantization, filtering, entropy encoding, etc., as described below in detail.

Similarly, as shown in FIG. 3, in decoding system 300, processor 202 may include one or more modules, such as a decoder 301. Although FIG. 3 shows that decoder 301 is within one processor 202, it is understood that decoder 301 may include one or more sub-modules that can be implemented on different processors located closely or remotely with each other. Decoder 301 (and any corresponding sub-modules or sub-units) can be hardware units (e.g., portions of an integrated circuit) of processor 202 designed for use with other components or software units implemented by processor 202 through executing at least part of a program, i.e., instructions. The instructions of the program may be stored on a computer-readable medium, such as memory 204, and when executed by processor 202, it may perform a process having one or more functions related to video decoding, such as entropy decoding, inverse quantization, inverse transformation, inter prediction, intra prediction, filtering, as described below in detail.

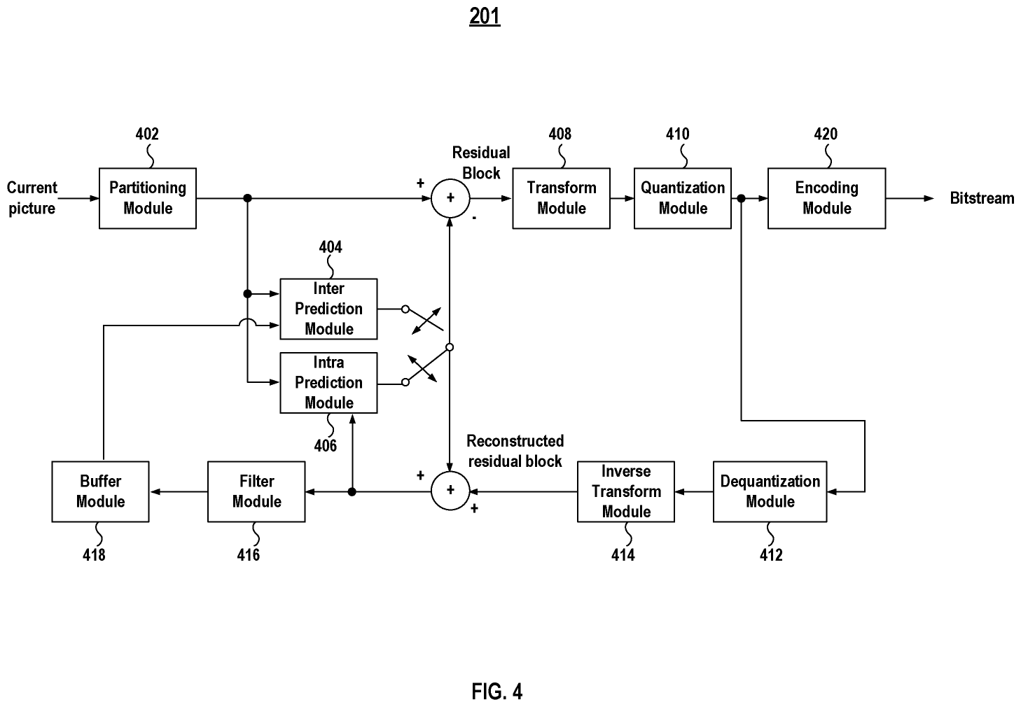

FIG. 4 illustrates a detailed block diagram of exemplary encoder 201 in encoding system 200 in FIG. 2, according to some embodiments of the present disclosure. As shown in FIG. 4, encoder 201 may include a partitioning module 402, an inter prediction module 404, an intra prediction module 406, a transform module 408, a quantization module 410, a dequantization module 412, an inverse transform module 414, a filter module 416, a buffer module 418, and an encoding module 420. It is understood that each of the elements shown in FIG. 4 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 201.

Partitioning module 402 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples. At this point, the processing unit may be a prediction unit (PU), a transform unit (TU), or a coding unit (CU). Partitioning module 402 may partition a picture into a combination of a plurality of coding units, prediction units, and transform units, and encode a picture by selecting a combination of a coding unit, a prediction unit, and a transform unit based on a predetermined criterion (e.g., a cost function).

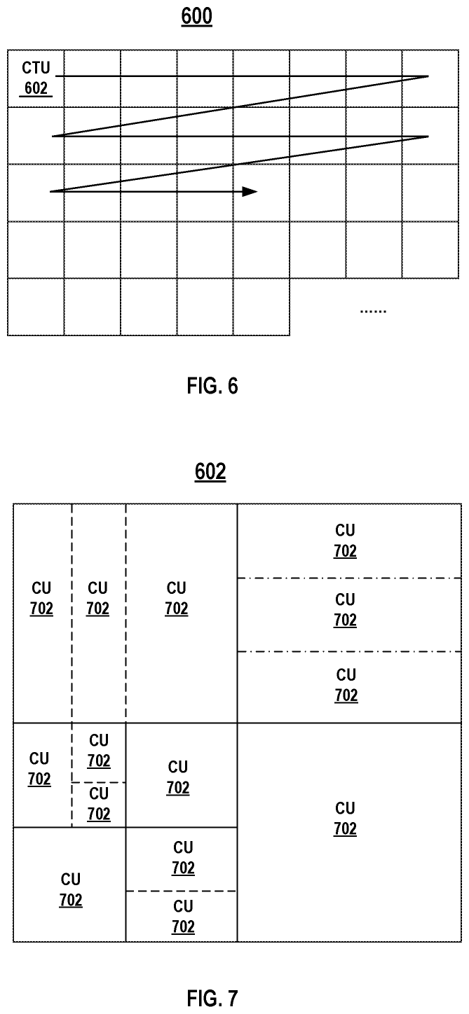

Similar to H.265/HEVC, H.266/NVC is a block-based hybrid spatial and temporal predictive coding scheme. As shown in FIG. 6, during encoding, an input picture 600 is first divided into square blocks—CTUs 602, by partitioning module 402. For example, CTUs 602 can be blocks of 128×128 pixels. As shown in FIG. 7, each CTU 602 in picture 600 can be partitioned by partitioning module 402 into one or more CUs 702, which can be used for prediction and transformation. Unlike H.265/HEVC, in H.266VVC, CUs 702 can be rectangular or square, and can be coded without further partitioning into prediction units or transform units. For example, as shown in FIG. 7, the partition of CTU 602 into CUs 702 may include quadtree splitting (indicated in solid lines), binary tree splitting (indicated in dashed lines), and temary splitting (indicated in dash-dotted lines). Each CU 702 can be as large as its root CTU 602 or be subdivisions of root CTU 602 as small as 4×4 blocks, according to some embodiments.

Referring to FIG. 4, inter prediction module 404 may be configured to perform inter prediction on a prediction unit, and intra prediction module 406 may be configured to perform intra prediction on the prediction unit. It may be determined whether to use inter prediction or to perform intra prediction for the prediction unit, and determine specific information (e.g., intra prediction mode, motion vector, reference picture, etc.) according to each prediction method. At this point, a processing unit for performing prediction may be different from a processing unit for determining a prediction method and specific content. For example, a prediction method and a prediction mode may be determined in a prediction unit, and prediction may be performed in a transform unit. Residual coefficients in a residual block between the generated prediction block and the original block may be input into transform module 408. In addition, prediction mode information, motion vector information, and the like used for prediction may be encoded by encoding module 420 together with the residual coefficients or quantization levels into the bitstream. It is understood that in certain encoding modes, an original block may be encoded as it is without generating a prediction block through prediction module 404 or 406. It is also understood that in certain encoding modes, prediction, transform, and/or quantization may be skipped as well.

In some embodiments, inter prediction module 404 may predict a prediction unit based on information on at least one picture among pictures before or after the current picture, and in some cases, it may predict a prediction unit based on information on a partial area that has been encoded in the current picture. Inter prediction module 404 may include sub-modules, such as a reference picture interpolation module, a motion prediction module, and a motion compensation module (not shown). For example, the reference picture interpolation module may receive reference picture information from buffer module 418 and generate pixel information of an integer number of pixels or less from the reference picture. In the case of a luminance pixel, a discrete cosine transform (DCT)-based 8-tap interpolation filter with a varying filter coefficient may be used to generate pixel information of an integer number of pixels or less by the unit of ¼ pixels. In the case of a color difference signal, a DCT-based 4-tap interpolation filter with a varying filter coefficient may be used to generate pixel information of an integer number of pixels or less by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

Still referring to FIG. 4, inter prediction module 404 may be configured to implement an exemplary inter prediction procedure. For example, inter prediction module 404 may extend the number of possible α values, as shown below in Tables 3 and 4.

TABLE 3
First exemplary extension of add_hyp_weight_idx

| add_hyp_weight_idx | α |
|---|---|
| 0 | ¼ |
| 1 | ⅛ |
| 2 | −⅛ |
| 3 | −¼ |

| add_hyp_weight_idx | α |
|---|---|
| 0 | ¼ |
| 1 | −⅛ |
| 2 | ⅛ |
| 3 | −¼ |

Having more candidates for weighting factor α may cause an increase in overhead bits, and hence, a loss in coding efficiency if this extension is applied to smaller templates (also referred to as “prediction blocks”). To solve this problem, the exemplary inter prediction procedure proposes the following restrictions. For example, in some embodiments, if the number of pixels of a prediction block is less than 256, the candidate weighting factors shown in Table 1 are applied. Otherwise, the candidate weighting factors shown in Table 3 or in Table 4 may be applied. In some other embodiments, if the width or height of the prediction block is less than 16, the candidate weighting factors shown in Table 1 are applied; otherwise, the candidate weighting factors shown in Table 3 or in Table 4 are applied.

Additionally and/or alternatively, inter prediction module 404 may code the absolute value and the sign of a as follows. For example, the syntax element add_hyp_weight_abs_idx is defined as shown in Table 5.

TABLE 5
Example of Extension of add_hyp_weight_abs_idx

| add_hyp_weight_abs_idx | abs(α) |
|---|---|
| 0 | ¼ |
| 1 | ⅛ |

In this case, the syntax of mh_pred_data( ) is modified as shown below in Table 6.

TABLE 6
Modified Syntax of mh_pred_data( )

| | Descriptor |
|---|---|
| mh_pred_data( ) { | |
| ... | |
| add_hyp_weight_abs_idx | ae(v) |
| add_hyp_weight_sign | ae(v) |
| ... | |
| } | |

The add_hyp_weight_abs_idx and add_hyp_weight_sign syntax elements may specify the value of the additional weight used for multi-hypothesis prediction. The sign of additional weight sign (α) is specified as:

$$if ( add\_hyp \_weight \_abs \_idx ) sign ( α ) = + 1$$

$$else sign ( α ) = - 1.$$

The absolute value abs(α) of the weight α may include one of the values illustrated above in Table 5.

The weighting factor value α for multi-hypothesis prediction may be calculated according to expression (3).

$$α = sign ( α ) * abs ( α ) . \qquad ( 3 )$$

The weighting factor α is applied to expression (1) in the process of MHP. It is also possible that the extended syntax element add_hyp_weight_idx as shown in Table 3 or Table 4 is not transmitted within the bitstream; instead, the optimal weight is selected with TM both at encoder 201 and decoder 301. For example, the extended add_hyp_weight_idx identified by decoder 301 after applying TM and/or MHP over current template 108 in FIG. 1 may be used to decode current CU 106.

Still referring to FIG. 4, in some embodiments, intra prediction module 406 may generate a prediction unit based on the information on reference pixels around the current block, which is pixel information in the current picture. The reference pixels may be located in reference lines non-adjacent to the current block. When a block in the neighborhood of the current prediction unit is a block on which inter prediction has been performed and thus, the reference pixel is a pixel on which inter prediction has been performed, the reference pixel included in the block on which inter prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. If the size of the prediction unit is the same as the size of the transform unit when intra prediction is performed, the intra prediction may be performed for the prediction unit based on pixels on the left side, pixels on the top-left side, and pixels on the top of the prediction unit. However, if the size of the prediction unit is different from the size of the transform unit when the intra prediction is performed, the intra prediction may be performed using a reference pixel based on the transform unit.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information predicted from the neighboring prediction unit, if the intra prediction modes of the current prediction unit are the same as the prediction unit in the neighborhood, information indicating that the prediction modes of the current prediction unit is the same as the prediction unit in the neighborhood may be transmitted using predetermined flag information, and if the prediction modes of the current prediction unit and the prediction unit in the neighborhood are different from each other, prediction mode information of the current block may be encoded by extra flags information.

As shown in FIG. 4, a residual block including a prediction unit that has performed prediction based on the prediction unit generated by prediction module 404 or 406 and residual coefficient information, which is a difference value of the prediction unit with the original block, may be generated. The generated residual block may be input into transform module 408.

Transform module 408 may be configured to transform the residual block including the original block and the residual coefficient information of the prediction unit generated through prediction modules 404 and 406 using a transform method, such as DCT, discrete sine transform (DST), Karhunen-Love transform (KLT), or transform skip. Whether to apply the DCT, the DST, or the KLT to transform the residual block may be determined based on intra prediction mode information of a prediction unit used to generate the residual block. Transform module 408 can transform the video signals in the residual block from the pixel domain to a transform domain (e.g., a frequency domain depending on the transform method). It is understood that in some examples, transform module 408 may be skipped, and the video signals may not be transformed to the transform domain.

Quantization module 410 may be configured to quantize the coefficient of each position in the coding block to generate quantization levels of the positions. The current block may be the residual block. That is, quantization module 410 can perform a quantization process on each residual block. The residual block may include N×M positions (samples) each associated with a transformed or non-transformed video signal/data, such as luma and/or chroma information, where N and Mare positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a. inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 410. Which quantizer will be used for quantizing the current coefficient may depend on the information preceding the current coefficient in coding scan order. Such a quantization process is referred to as dependent quantization.

Referring to FIG. 4, encoding module 420 may be configured to encode the quantization level of each position in the coding block into the bitstream. In some embodiments, encoding module 420 may perform entropy encoding on the coding block. Entropy encoding may use various binarization methods, such as Golomb-Rice binarization, including converting each quantization level into a respective binary representation, such as binary bins. Then, the binary representation can be further compressed using entropy encoding algorithms. The compressed data may be added to the bitstream. Besides the quantization levels, encoding module 420 may encode various other information, such as block type information of a coding unit, prediction mode information, partitioning unit information, prediction unit information, transmission unit information, motion vector information, reference frame information, block interpolation information, and filtering information input from, for example, prediction modules 404 and 406. In some embodiments, encoding module 420 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined TR and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of CABAC can support two operating modes: a context coding mode, in which the bins are coded with adaptive probability models, and a less complex bypass mode that uses fixed probabilities of ½. The adaptive probability models are also called contexts, and the assignment of probability models to individual bins is referred to as context modeling.

As shown in FIG. 4 dequantization module 412 may be configured to dequantize the quantization levels by dequantization module 412, and inverse transform module 414 may be configured to inversely transform the coefficients transformed by transform module 408. The reconstructed residual block generated by dequantization module 412 and inverse transform module 414 may be combined with the prediction units predicted through prediction module 404 or 406 to generate a reconstructed block.

Filter module 416 may include at least one among a deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video and the original video. Buffer module 418 may be configured to store the reconstructed block or picture calculated through filter module 416, and the reconstructed and stored block or picture may be provided to inter prediction module 404 when inter prediction is performed.

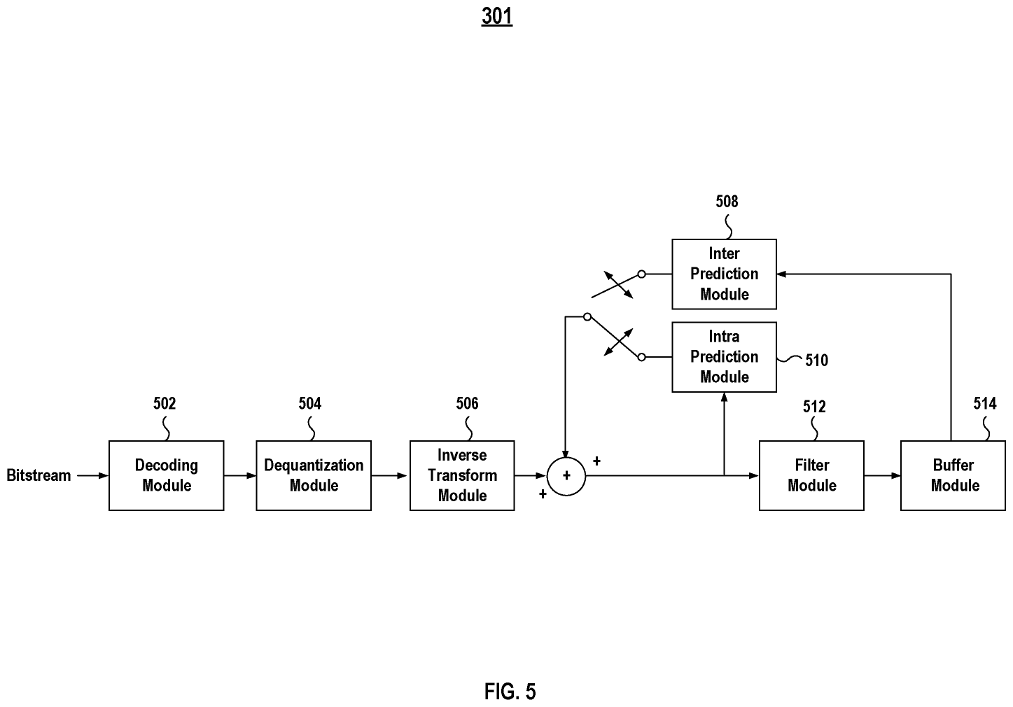

FIG. 5 illustrates a detailed block diagram of exemplary decoder 301 in decoding system 300 in FIG. 3, according to some embodiments of the present disclosure. As shown in FIG. 5, decoder 301 may include a decoding module 502, a dequantization module 504, an inverse transform module 506, an inter prediction module 508, an intra prediction module 510, a filter module 512, and a buffer module 514. It is understood that each of the elements shown in FIG. 5 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 301.

When a video bitstream is input from a video encoder (e.g., encoder 201), the input bitstream may be decoded by decoder 301 in a procedure opposite to that of the video encoder. Thus, some details of decoding that are described above with respect to encoding may be skipped for ease of description. Decoding module 502 may be configured to decode the bitstream to obtain various information encoded into the bitstream, such as the quantization level of each position in the coding block. In some embodiments, decoding module 502 may perform entropy decoding (decompressing) corresponding to the entropy encoding (compressing) performed by the encoder, such as, for example, VLC, CAVLC, CABAC, SBAC, PIPE coding, and the like to obtain the binary representation (e.g., binary bins). Decoding module 502 may further convert the binary representations to quantization levels using Golomb-Rice binarization, including, for example, EGk binarization and combined TR and limited EGk binarization. Besides the quantization levels of the positions in the transform units, decoding module 502 may decode various other information, such as the parameters used for Golomb-Rice binarization (e.g., the Rice parameter), block type information of a coding unit, prediction mode information, prediction unit information, transmission unit information, motion vector information, reference frame information, block interpolation information, and filtering information. During the decoding process, decoding module 502 may perform rearrangement on the bitstream to reconstruct and rearrange the data from a 1D order into a 2D rearranged block through a method of inverse-scanning based on the coding scan order used by the encoder.

Dequantization module 504 may be configured to dequantize the quantization level of each position of the coding block (e.g., the 2D reconstructed block) to obtain the coefficient of each position. In some embodiments, dequantization module 504 may perform dependent dequantization based on quantization parameters provided by the encoder as well, including the information related to the quantizers used in dependent quantization, for example, the quantization step size used by each quantizer.

Inverse transform module 506 may be configured to perform inverse transformation, for example, inverse DCT, inverse DST, and inverse KLT, for DCT, DST, and KLT performed by the encoder, respectively, to transform the data from the transform domain (e.g., coefficients) back to the pixel domain (e.g., luma and/or chroma information). In some embodiments, inverse transform module 506 may selectively perform a transform operation (e.g., DCT, DST, KLT) according to a plurality of pieces of information such as a prediction method, a size of the current block, a prediction direction, and the like.

Inter prediction module 508 and intra prediction module 510 may be configured to generate a prediction block based on information related to the generation of a prediction block provided by decoding module 502 and information of a previously decoded block or picture provided by buffer module 514. As described above, if the size of the prediction unit and the size of the transform unit are the same when intra prediction is performed in the same manner as the operation of the encoder, intra prediction may be performed on the prediction unit based on the pixel existing on the left side, the pixel on the top-left side, and the pixel on the top of the prediction unit. However, if the size of the prediction unit and the size of the transform unit are different when intra prediction is performed, intra prediction may be performed using a reference pixel based on a transform unit.

For example, inter prediction module 508 may be configured to receive a bitstream that includes a reference frame, a current frame, and an indication of a weighting factor associated with an MHP procedure from an encoder. Inter prediction module 508 may be configured to perform the MHP procedure for a CU located in the current frame based on a search block (e.g., reference frame and/or reference template) in the reference frame. In some embodiments, to perform the MHP procedure, the inter prediction module 508 may be configured to perform template matching for the CU located in the current frame based on a search block in the reference frame and the weighting factor to obtain motion information. In some embodiments, to perform the MHP procedures, inter prediction module 508 may be configured to identify a weighting factor index associated with the weighting factor based on the template matching. Inter prediction module 508 may be configured to identify a weighting factor sign of the weighting factor based on an indication included in the bitstream. Inter prediction module performs an inter prediction procedure based on the current frame, the reference frame, the weighting factor index, and the weighting factor sign of the weighting factor to decode the bitstream.

The reconstructed block or reconstructed picture combined from the outputs of inverse transform module 506 and prediction module 508 or 510 may be provided to filter module 512. Filter module 512 may include a deblocking filter, an offset correction module, and an ALF. Buffer module 514 may store the reconstructed picture or block and use it as a reference picture or a reference block for inter prediction module 508 and may output the reconstructed picture.

Consistent with the scope of the present disclosure, encoding module 420 and decoding module 502 may be configured to adopt a scheme of quantization level binarization with Rice parameter adapted to the bit depth and/or the bit rate for encoding the picture of the video to improve the coding efficiency.

FIG. 8 illustrates a flowchart of an exemplary method 800 of video encoding, according to some embodiments of the present disclosure. Method 800 may be performed by a system, e.g., such as encoding system 200, encoder 201, or inter prediction module 404, just to name a few. Method 800 may include operations 802-814, as described below. It is to be appreciated that some of the steps may be optional, and some of the steps may be performed simultaneously, or in a different order than shown in FIG. 8.

Referring to FIG. 8, at 802, the system may receive a set of frames including a reference frame and a current frame. For example, referring to FIG. 4, inter prediction module 404 may receive a set of frames that includes a current frame and a reference frame.

At 804, the system may perform an MHP procedure for a CU located in the current frame based on a search block in the reference frame. For example, referring to FIG. 4, inter prediction module 404 may be configured to implement an exemplary inter prediction procedure. For example, inter prediction module 404 may extend the number of possible α values, as shown above in Tables 3 and 4.

At 806, the system may determine whether the size of the search block in the reference frame meets a threshold value. For example, referring to FIG. 4, having more candidates for weighting factor α may cause an increase in overhead bits, and hence, a loss in coding efficiency if this extension is applied to smaller templates (also referred to as “prediction blocks”). To solve this problem, the exemplary inter prediction procedure proposes the following restrictions. For example, in some embodiments, if the number of pixels of a prediction block is less than a threshold value (e.g., 256 pixels), the candidate weighting factors shown in Table 1 are applied. Otherwise, the candidate weighting factors shown in Table 3 or in Table 4 may be applied. In some other embodiments, if the width or height of the prediction block is less than a threshold value (e.g., 16 pixels), the candidate weighting factors shown in Table 1 are applied; otherwise, the candidate weighting factors shown in Table 3 or in Table 4 are applied. If “Yes” at 806, the operations may move to 808; otherwise, if “No” at 806,” the operations may move to 810.

At 808, the system may select a first weighting factor from a first set of more than two weighting factors associated with the MHP procedure. For example, referring to FIG. 4, if the number of pixels in the prediction block (e.g., current CU and/or current frame) is less than a threshold number (e.g., 256 pixels) the candidate weighting factors shown in Table 3 or Table 4 may be applied; or if the width or height of the prediction block meets a threshold value (e.g., 16 bits), the candidate weighting factors shown in Tables 3 or Table 4 are applied.

At 810, the system may select a second weighting factor from a second set of two weighting factors associated with the MHP procedure. For example, referring to FIG. 4, if the number of pixels of a prediction block is less than the threshold value (e.g., 256 bits), the candidate weighting factors shown in Table 1 are applied; or if the width or height of the prediction block is less than a threshold value (e.g., 16 bits), the candidate weighting factors shown in Table 1 are applied.

At 812, the system may identify a weighting factor sign associated with the first weighting factor. For example, referring to FIG. 4, inter prediction module 404 may code the absolute value and the sign of a as described above. For example, the syntax element add_hyp_weight_abs_idx is defined as shown in Table 5. In this case, the syntax of mh_pred_data( ) is modified as shown below in Table 6. The add_hyp_weight_abs_idx and add_hyp_weight_sign syntax elements may specify the value of the additional weight used for multi-hypothesis prediction. The sign of additional weight sign(α) is specified as described above. The absolute value abs(α) of the weight α may include one of the values illustrated above in Table 5. The weighting factor value α for multi-hypothesis prediction may be calculated according to expression (3). The weighting factor α is applied to expression (1) in the process of MHP. It is also possible that the extended syntax element add_hyp_weight_idx as shown in Table 3 or Table 4 is not transmitted within the bitstream; instead, the optimal weight is selected with TM both at encoder 201 and decoder 301. For example, the extended add_hyp_weight_idx identified by decoder 301 after applying TM and/or MHP over current template 108 in FIG. 1 may be used to decode current CU 106.

At 814, the system may send an indication of the weighting factor sign associated with the first weighting factor in a bitstream. For example, referring to FIG. 4, the extended syntax element add_hyp_weight_idx, as shown in Table 3 or Table 4, is not transmitted within the bitstream; instead, only the sign of the weighting factor may be indicated. In this case, decoder 301 may identify the absolute value of the weighting factor based on TM.

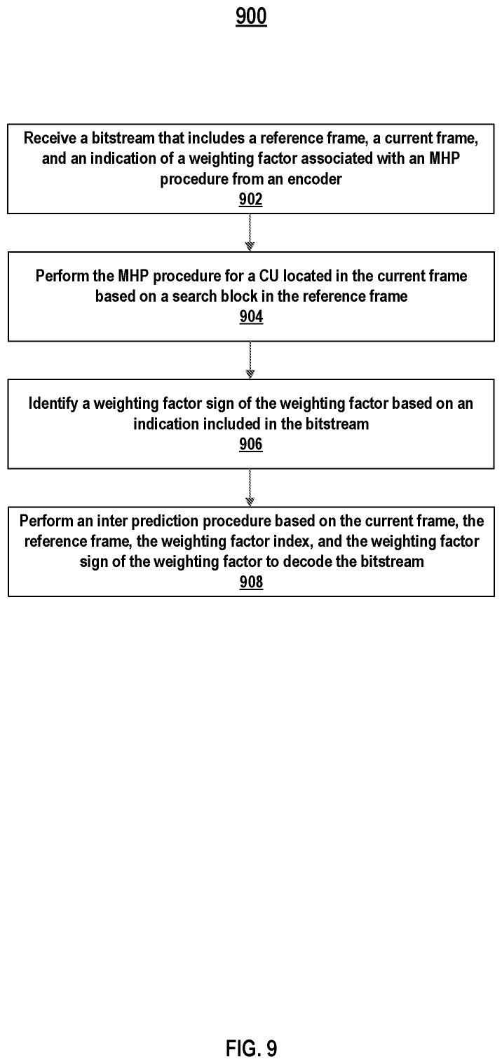

FIG. 9 illustrates a flowchart of an exemplary method 900 of video decoding, according to some embodiments of the present disclosure. Method 900 may be performed by a system, e.g., such as decoding system 300, decoder 301, or intra prediction module 510, just to name a few. Method 900 may include operations 902-908, as described below. It is to be appreciated that some of the steps may be optional, and some of the steps may be performed simultaneously, or in a different order than shown in FIG. 9.

Referring to FIG. 9, at 902, the system may receive a bitstream that includes a reference frame, a current frame, and an indication of a weighting factor associated with an MHP procedure from an encoder. For example, referring to FIG. 5, inter prediction module 508 may be configured to receive a bitstream that includes a reference frame, a current frame, and an indication of a weighting factor associated with an MHP procedure from an encoder.

At 904, the system may perform the MHP procedure for a CU located in the current frame based on a search block in the reference frame. For example, referring to FIG. 5, inter prediction module 508 may be configured to perform the MHP procedure for a CU located in the current frame based on a search block in the reference frame. In some embodiments, to perform the MHP procedure, the inter prediction module 508 may be configured to perform template matching for the CU located in the current frame based on a search block in the reference frame and the weighting factor to obtain motion information. In some embodiments, to perform the MHP procedures, inter prediction module 508 may be configured to identify a weighting factor index associated with the weighting factor based on the template matching.

At 906, the system may identify a weighting factor sign of the weighting factor based on an indication included in the bitstream. For example, referring to FIG. 5, inter prediction module 508 may be configured to identify a weighting factor sign of the weighting factor based on an indication included in the bitstream.

At 908, the system may perform an inter prediction procedure based on the current frame, the reference frame, the weighting factor index, and the weighting factor sign of the weighting factor to decode the bitstream. For example, referring to FIG. 5, inter prediction module perform an inter prediction procedure based on the current frame, the reference frame, the weighting factor index, and the weighting factor sign of the weighting factor to decode the bitstream.

By extending the candidates of weight for MHP, the exemplary inter prediction procedure of the present disclosure may achieve increased coding efficiency, as compared to existing inter prediction procedures. In addition, by restricting the application of extended weights depending on the prediction block size, or coding the absolute value and the sign of the weighting factor separately, or by determining the index for MHP weighting factor with template matching, the exemplary inter predication procedure described herein reduces the amount of overhead bits in the bitstream.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 202 in FIGS. 2 and 3. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of encoding by an encoder is provided. The method may include receiving, by at least one processor, a set of frames including a reference frame and a current frame. The method may include performing, by the at least one processor, an MHP procedure for a CU located in the current frame based on a search block in the reference frame. In response to a size of the search block in the reference frame meeting a threshold size, the method may include selecting, by the at least one processor, a first weighting factor from a first set of more than two weighting factors associated with the MHP procedure.

In some embodiments, in response to the size of the search block in the reference frame not meeting the threshold size, the method may include selecting, by the at least one processor, a second weighting factor from a second set of two weighting factors associated with the MHP procedure.

In some embodiments, the threshold size is associated with a total number of pixels within the search block.

In some embodiments, the threshold size may be associated with a height-wise or width-wise number of pixels of the search block.

In some embodiments, the performing, by the at least one processor, the MHP procedure for the CU located in the current frame based on a search block in the reference frame may include obtaining, by the at least one processor, motion information associated with the CU located in the current frame based and the search block in the reference frame using template matching. In some embodiments, the performing, by the at least one processor, the MHP procedure for the CU located in the current frame based on a search block in the reference frame may include encoding, by the at least one processor, the current frame based on the motion information and the first weighting factor. In some embodiments, the first weighting factor may be selected based on the motion information obtained via template matching.

In some embodiments, the method may include identifying, by at least one processor, a weighting factor sign associated with the first weighting factor. In some embodiments, the method may include sending, by the at least one processor, an indication of the weighting factor sign associated with the first weighting factor in a bitstream.

According to another aspect of the present disclosure, a system for encoding is provided. The system may include at least one processor and memory storing instructions. The memory storing instructions, which when executed by the at least one processor, may cause the at least one processor to receive a set of frames including a reference frame and a current frame. The memory storing instructions, which when executed by the at least one processor, may cause the at least one processor to perform an MHP procedure for a CU located in the current frame based on a search block in the reference frame. In response to a size of the search block in the reference frame meeting a threshold size, the memory storing instructions, which when executed by the at least one processor, may cause the at least one processor to select a first weighting factor from a first set of more than two weighting factors associated with the MHP procedure.

In some embodiments, in response to the size of the search block in the reference frame not meeting the threshold size, the memory storing instructions, which when executed by the at least one processor, may cause the at least one processor to select a second weighting factor from a second set of two weighting factors associated with the MHP procedure.

In some embodiments, the threshold size may be associated with a total number of pixels within the search block.

In some embodiments, the threshold size may be associated with a height-wise or width-wise number of pixels of the search block.

In some embodiments, to perform the MHP procedure for the CU located in the current frame based on a search block in the reference frame, the memory storing instructions, which when executed by the at least one processor, may cause the at least one processor to obtain motion information associated with the C U located in the current frame based and the search block in the reference frame using template matching. In some embodiments, to perform the MHP procedure for the CU located in the current frame based on a search block in the reference frame, the memory storing instructions, which when executed by the at least one processor, may cause the at least one processor to encode the current frame based on the motion information and the first weighting factor. In some embodiments, the first weighting factor may be selected based on the motion information obtained via template matching.

In some embodiments, the memory storing instructions, which when executed by the at least one processor, may further cause the at least one processor to identify a weighting factor sign associated with the first weighting factor. In some embodiments, the memory storing instructions, which when executed by the at least one processor, may further cause the at least one processor to send an indication of the weighting factor sign associated with the first weighting factor in a bitstream.

According to a further aspect of the present disclosure, a method of decoding by a decoder is provided. The method may include receiving, by at least one processor, a bitstream that includes a reference frame, a current frame, and an indication of a weighting factor associated with an MHP procedure from an encoder. The weighting factor may be associated with a first set of more than two weighting factors when a size of a search block in the reference frame meets a threshold size. The method may include performing, by the at least one processor, the MHP procedure for a CU located in the current frame based on a search block in the reference frame.

In some embodiments, the weighting factor may be associated with a second set of two weighting factors when the size of the search block in the reference frame does not meet the threshold size.

In some embodiments, the threshold size may be associated with a total number of pixels within the search block.

In some embodiments, the threshold size may be associated with a height-wise or width-wise number of pixels of the search block.

In some embodiments, the performing, by the at least one processor, the MHP procedure for the CU located in the current frame based on the search block in the reference frame may include performing template matching for the CU located in the current frame based on a search block in the reference frame and the weighting factor to obtain motion information. In some embodiments, the performing, by the at least one processor, the MHP procedure for the CU located in the current frame based on the search block in the reference frame may include identifying a weighting factor index associated with the weighting factor based on the template matching.

In some embodiments, the method may include identifying, by the at least one processor, a weighting factor sign of the weighting factor based on an indication included in the bitstream. In some embodiments, the method may include performing, by the at least one processor, an inter prediction procedure based on the current frame, the reference frame, the weighting factor index, and the weighting factor sign of the weighting factor to decode the bitstream.

According to yet another aspect of the present disclosure, a system for decoding by a decoder. The system may include at least one processor and memory storing instructions. The memory storing instructions, which when executed by the at least one processor, may cause the at least one processor to receive a bitstream that includes a reference frame, a current frame, and an indication of a weighting factor associated with an MHP procedure from an encoder. The weighting factor may be associated with a first set of more than two weighting factors when a size of a search block in the reference frame meets a threshold size. The memory storing instructions, which when executed by the at least one processor, may cause the at least one processor to perform the MHP procedure for a C U located in the current frame based on a search block in the reference frame.

In some embodiments, the weighting factor may be associated with a second set of two weighting factors when the size of the search block in the reference frame does not meet the threshold size.

In some embodiments, the threshold size may be associated with a total number of pixels within the search block.

In some embodiments, the threshold size may be associated with a height-wise or width-wise number of pixels of the search block.

In some embodiments, to perform the MHP procedure for the CU located in the current frame based on the search block in the reference frame, the memory storing instructions, which when executed by the at least one processor, may cause the at least one processor to perform template matching for the CU located in the current frame based on a search block in the reference frame and the weighting factor to obtain motion information. In some embodiments, to perform the MHP procedure for the CU located in the current frame based on the search block in the reference frame, the memory storing instructions, which when executed by the at least one processor, may cause the at least one processor to identify a weighting factor index associated with the weighting factor based on the template matching.

In some embodiments, the memory storing instructions, which when executed by the at least one processor, may further cause the at least one processor to identify a weighting factor sign of the weighting factor based on an indication included in the bitstream. In some embodiments, the memory storing instructions, which when executed by the at least one processor, may further cause the at least one processor to perform an inter prediction procedure based on the current frame, the reference frame, the weighting factor index, and the weighting factor sign of the weighting factor to decode the bitstream.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of encoding by an encoder, comprising:
receiving, by at least one processor, a set of frames including a reference frame and a current frame;
performing, by the at least one processor, a multi-hypothesis prediction (MHP) procedure for a coding unit (CU) located in the current frame based on a search block in the reference frame; and
in response to a size of the search block in the reference frame meeting a threshold size, selecting, by the at least one processor, a first weighting factor from a first set of more than two weighting factors associated with the MHP procedure.

2. The method of claim 1, further comprising:
in response to the size of the search block in the reference frame not meeting the threshold size, selecting, by the at least one processor, a second weighting factor from a second set of two weighting factors associated with the MHP procedure.

3. The method of claim 2, wherein the threshold size is associated with a total number of pixels within the search block.

4. The method of claim 2, wherein the threshold size is associated with a height-wise or width-wise number of pixels of the search block.

5. The method of claim 1, wherein the performing, by the at least one processor, the MHP procedure for the CU located in the current frame based on a search block in the reference frame comprises:
obtaining, by the at least one processor, motion information associated with the CU located in the current frame based and the search block in the reference frame using template matching; and
encoding, by the at least one processor, the current frame based on the motion information and the first weighting factor,
wherein the first weighting factor is selected based on the motion information obtained via template matching.

6. The method of claim 1, further comprising:
identifying, by at least one processor, a weighting factor sign associated with the first weighting factor; and
sending, by the at least one processor, an indication of the weighting factor sign associated with the first weighting factor in a bitstream.

7-12. (canceled)

13. A method of decoding by a decoder, comprising:
receiving, by at least one processor, a bitstream that includes a reference frame, a current frame, and an indication of a weighting factor associated with a multi-hypothesis prediction (MHP) procedure from an encoder, the weighting factor being associated with a first set of more than two weighting factors when a size of a search block in the reference frame meets a threshold size; and
performing, by the at least one processor, the MHP procedure for a coding unit (CU) located in the current frame based on a search block in the reference frame.

14. The method of claim 13, wherein the weighting factor is associated with a second set of two weighting factors when the size of the search block in the reference frame does not meet the threshold size.

15. The method of claim 14, wherein the threshold size is associated with a total number of pixels within the search block.

16. The method of claim 14, wherein the threshold size is associated with a height-wise or width-wise number of pixels of the search block.

17. The method of claim 13, wherein the performing, by the at least one processor, the MHP procedure for the CU located in the current frame based on the search block in the reference frame comprises:
performing template matching for the CU located in the current frame based on a search block in the reference frame and the weighting factor to obtain motion information; and
identifying a weighting factor index associated with the weighting factor based on the template matching.

18. The method of claim 17, further comprising:
identifying, by the at least one processor, a weighting factor sign of the weighting factor based on an indication included in the bitstream; and
performing, by the at least one processor, an inter prediction procedure based on the current frame, the reference frame, the weighting factor index, and the weighting factor sign of the weighting factor to decode the bitstream.

19. A system for decoding by a decoder, comprising:
at least one processor; and
memory storing instructions, which when executed by the at least one processor, cause the at least one processor to:
receive a bitstream that includes a reference frame, a current frame, and an indication of a weighting factor associated with a multi-hypothesis prediction (MHP) procedure from an encoder, the weighting factor being associated with a first set of more than two weighting factors when a size of a search block in the reference frame meets a threshold size; and
perform the MHP procedure for a coding unit (CU) located in the current frame based on a search block in the reference frame.

20. The system of claim 19, wherein the weighting factor is associated with a second set of two weighting factors when the size of the search block in the reference frame does not meet the threshold size.

21. The system of claim 20, wherein the threshold size is associated with a total number of pixels within the search block.

22. The system of claim 20, wherein the threshold size is associated with a height-wise or width-wise number of pixels of the search block.

23. The system of claim 19, wherein, to perform the MHP procedure for the CU located in the current frame based on the search block in the reference frame, the memory storing instructions, which when executed by the at least one processor, cause the at least one processor to:
perform template matching for the CU located in the current frame based on a search block in the reference frame and the weighting factor to obtain motion information; and
identify a weighting factor index associated with the weighting factor based on the template matching.

24. The system of claim 23, wherein the memory storing instructions, which when executed by the at least one processor, further cause the at least one processor to:
identify a weighting factor sign of the weighting factor based on an indication included in the bitstream; and
perform an inter prediction procedure based on the current frame, the reference frame, the weighting factor index, and the weighting factor sign of the weighting factor to decode the bitstream.
